(19) United States
(12) Patent Application Publication
(10) Pub. No.: US 2018/0123731 A1
(43) Pub. Date: May 3, 2018

(54) Reduced Latency for Initial Connection to Local Wireless Networks

(71) Applicant: Social Microphone, Inc., Palo Alto, CA (US)

(72) Inventors: Uwe Kummerow, Imperial Beach, CA (US); Rico Huber, Hamm (DE)

(21) Appl. No.: 15/339,780

(22) Filed: Oct. 31, 2016

(51) Int. Cl. H04L 1/00; H04L 29/06

(52) U.S. Cl. CPC H04L 1/0018; H04W 84/12; H04L 67/42

(57) ABSTRACT

Programmable personal mobile communications devices, such as smart phones, are used as microphones and/or cameras for a public display/address system over a local wireless network. The steps of operation of the computer/server controlling the local wireless network are designed and ordered to reduce the latency in initially connecting a programmable personal mobile communications device to the public address system over the local wireless network. Similarly, the steps of operation of the programmable personal mobile communications device are designed and ordered to reduce the latency in initially connecting the programmable personal mobile communications device to the public address system over the local wireless network.

### BACKGROUND OF THE INVENTION

The present invention relates to the fields of communications, particularly closed environment communication, local conferencing and the use of existing voice and data messaging systems.

In meetings, conferences, classrooms and the like, a typical question-and-answer period allows attendees and participants to ask questions from the floor. In a large venue without amplification, others in the room often have trouble hearing the speaker. Commonly, a microphone is provided in one or more aisles or a portable microphone is passed to a person wishing to ask a question. This can force people to maneuver their seating towards the aisles where microphone access might be more easily available, or cause some significant and disturbing activity in audiences and lead to disruption of the underlying meeting. The movement of the microphones through the audience can be tedious, slow (e.g., from one extreme corner of a room to another) and cumbersome. There can also be such significant jousting for attention as to be disconcerting to participants and lead to a loss of audience control. The current system also may not work because a microphone is not available, does not work well, or there is no portable microphone handy near the participant who wishes to speak. Often, the participant speaker doesn't properly use a microphone—waving it about or placing it too far away from his or her mouth while speaking—thus negating the advantages of the microphone.

To address these issues, U.S. patent application Ser. No. 13/844,412, filed Mar. 15, 2013 by Kenneth N. Sherman and Andrew Livingston, and entitled, “Mobile Microphone System and Method,” (which is herein incorporated by reference) and related patent applications (including U.S. Pat. Nos. 8,144,893 and 8,452,026) describe ways in which personal mobile communications devices, including smart phones, such as the Apple iPhone, Samsung Galaxy, and the like, cellular telephones, PDA's (Personal Digital Assistants), electronic tablets, such as the Apple iPad, the ASUS Nexus 7 and the like with mobile communication applications, WiFi and Bluetooth laptop processors (PC and Mac), and other hand-sized, computer-based communication devices, can be especially used at large meetings, gatherings, conferences, etc. as microphones. Wireless telephone networks and local wireless networks are used with the personal mobile communications devices of the attendees and participants of the meeting. Programmable personal mobile communications devices, such as smart phones, are especially adaptable to be used as microphones by applications, sometimes termed “apps.”

One problem which a user of a public address system notices is latency, not only the delay, for example, from the time an audience member or attendee speaks into a microphone until the appearance of his or her voice on the public address system, but also any delay in connecting a microphone to the public address system. Any delay in making a connection disrupts the flow of a meeting or gathering as the attendees wait for the microphone to become live. The present invention is directed toward minimizing the time for connecting programmable personal mobile communications devices, such as smart phones, to the public address system through a local wireless network.

### BRIEF SUMMARY OF THE INVENTION

The present invention provides for a method of operation by a computer/server controlling a local wireless network where the local wireless network provides a connection to one or more programmable personal mobile communications devices to a public display/address system. The method comprises: receiving signals through the local wireless network to initiate a connection from a selected programmable personal mobile communications device to the public display/address system through the local wireless communications network; initializing the processing of communications data from the selected programmable personal mobile communications device for playback over the public display/address system; waiting for the communications data from the selected programmable personal mobile communications device; sending signals through the local wireless network to the selected programmable personal mobile communications device to initiate connection from the selected programmable personal mobile communications device to the public display/address system through the local wireless network; receiving an initial packet of communications data over the local wireless network from the selected programmable personal mobile communications device; and responsive to the step of receiving the initial communications data packet, switching into a communications data processing state to playback the communications data from the selected programmable personal mobile communications device over the public display/address system. The time in initiating the connection of the programmable personal mobile communications device to the public display/address system is thereby reduced. The communications data may be audio data for playback over the public address system or video data for playback over the public display system.

The present invention also provides for a computer/server for controlling a local wireless network where the local wireless network provides a connection for one or more programmable personal mobile communications devices to a public display/address system. The computer/server comprises one or more processing units coupled to a memory holding instructions for one or more processing units. The one or more processing units are programmed to make a connection for a selected programmable personal mobile communications device to the public display/address system over the local wireless network in a minimized time interval by: receiving signals through the local wireless network to initiate a connection from a selected programmable personal mobile communications device to the public display/address system through the local wireless communications network; initializing the processing of communications data from the selected programmable personal mobile communications device for playback over the public display/address system; waiting for incoming communications data from the selected programmable personal mobile communications device; sending signals through the local wireless network to the selected programmable personal mobile communications device to initiate connection from the selected programmable personal mobile communications device to the public display/address system through the local wireless network; receiving an initial packet of communications data over the local wireless network from the selected programmable personal mobile communications device; and responsive to the step of receiving the initial communications data packet, switching into an communications data processing state to playback the communications data from the selected programmable personal mobile communications device over the public display/address system.

The present invention further provides for a method of operating a programmable personal mobile communications device in connecting the device to a public display/address system through a local wireless communications network. The method comprises: receiving signals to initiate connection to the public display/address system through the local wireless communications network; initiating capture of communications data from a microphone on the programmable personal mobile communications device into frames for transmission over the local wireless network; transmitting the frames encapsulating the communications data over the local wireless network to establish a stream of the frames of communications data over the local wireless network; and thereafter changing status indication on the personal mobile communications device to show connection of personal mobile communications device to the public display/address system; whereby latency in making the connection between the personal mobile communications device and the public display/address system is reduced.

The present invention provides for a programmable personal mobile communications device connectable to a public display/address system over a local wireless network. The programmable personal mobile communications device comprises one or more processing units coupled to a memory holding instructions for one or more processing units. The one or more processing units are programmed so that the programmable personal mobile communications device makes a connection to the public display/address system over the local wireless network by: receiving signals to initiate connection to the public display/address system through the local wireless communications network; initiating capture of communications data from a microphone on the programmable personal mobile communications device into frames for transmission over the local wireless network; transmitting the frames encapsulating the communications data over the local wireless network to establish a stream of the frames of communications data over the local wireless network; and thereafter changing status indication on the personal mobile communications device to show connection of personal mobile communications device to the public display/address system; whereby latency in making the connection between the personal mobile communications device and the public display/address system is reduced.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a representative meeting venue at which a conventional microphone is connected to a public address system.

FIG. 2 shows a representative meeting venue at which programmable personal mobile communications devices are used as microphones for the public address system over a local wireless network and where the present invention might be used to reduce latency in making the connection between a personal mobile communications device and the public address system over the local wireless network.

FIG. 3 is a flow chart of steps of the computer/server controlling the local wireless network in making the initial connection between a selected programmable personal mobile communications device and the public address system over the local wireless network with reduced latency, according to one embodiment of the present invention.

FIG. 4 is a flow chart of steps of a programmable personal mobile communications device in making the initial connection between the programmable personal mobile communications device and the public address system over the local wireless network with reduced latency, according to an embodiment of the present invention.

### DETAILED DESCRIPTION OF THE INVENTION

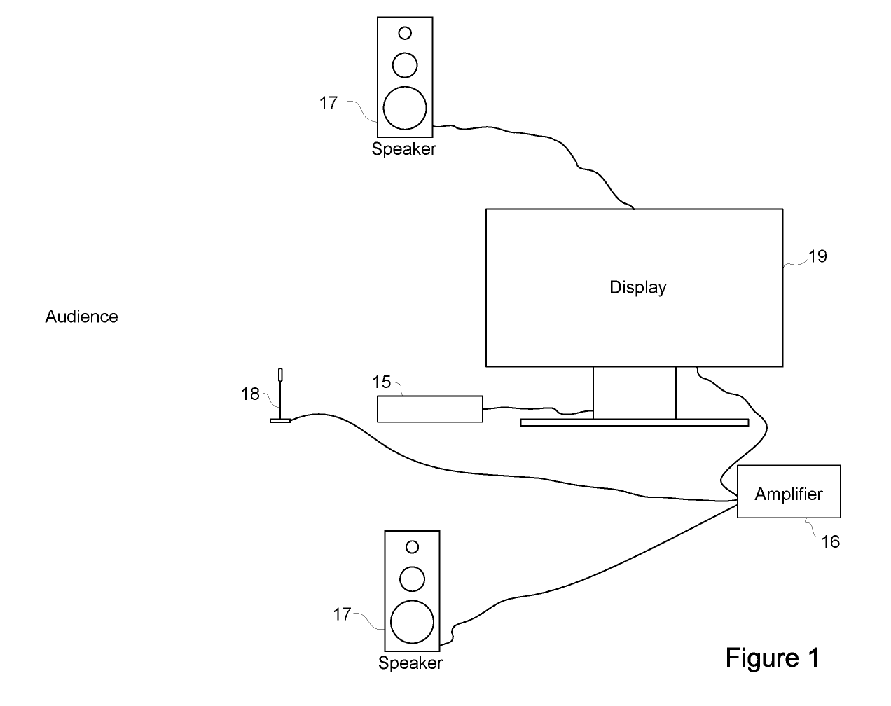

FIG. 1 is illustrative of meeting venues at which attendee/participants of such meetings and a moderator/host who manages such meetings might find the present invention very useful. At meetings, conventions, gatherings, conferences, worship services, classrooms, and the like, an audience and/or participants is typically addressed by a public address system formed by speakers 17 and one or more amplifiers 16 with a central microphone 18 handled by a human host/moderator. Besides audio communication, the audience might also receive additional information through a public display system 19, which may have more than one display, and a playback device 15. This is an ordinary audio-visual system which is typically found at meetings, gatherings, conferences, etc. today.

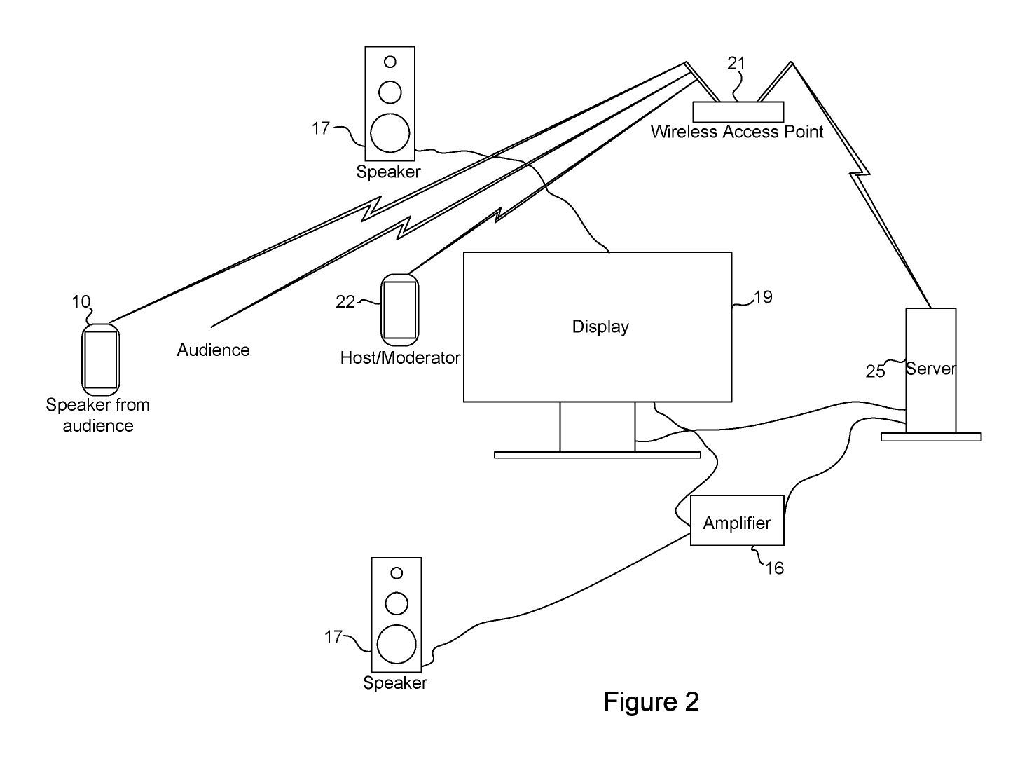

As described in the previously cited U.S. patent application Ser. No. 13/844,412, personal mobile communications devices in the audience can be used as microphones at such meetings, gatherings, conferences, etc. That is, the attendees/participants may use their personal mobile communications devices, including smart phones and the like, as microphones to address others in the room via the public address or sound amplification system. FIG. 2 is a representation which shows how such a system is adapted into an ordinary audio-visual system. The same reference numerals are used for the same or similar elements in FIG. 1.

Instead of a central microphone or conventional portable microphone(s), the programmable personal mobile communications devices of the audience members or attendees, as represented by the device 10, are used. These devices, such as smart phones or even lap top computers, are wirelessly connected by one or more wireless access points 21 to a control server or computer 25. Only one wireless access point 21 is shown in FIG. 2 for simplicity's sake. As shown here, the server 25 is wirelessly connected to the wireless access point 21 but alternatively may be connected to the wireless access point 21 by a wire. Note that the control server 25 may have its own local wireless network card, such as a WiFi card, to create a wireless access point 21 as part of the server 25 or act as a client.

The control server 25 may have one or more processors, memory elements, various input/output units, such as keyboards, mice, track balls and displays (including touch-sensitive displays), and network connection units. Though drawn as a standard computer, the control server 25 may be in the form of a laptop computer. The control server 25 is connected by the amplifier 16 of the public address system and to the display 19. A host/moderator 22 is also wirelessly connected to the control server 25 through the wireless access point 21, though the host/moderator may be connected directly to the control server 25 by wire. As in the case of the device 10, the host/moderator 22 represents both a personal computing and communications device and the user of that device. Specific language and context will guide the reader whether specific reference to the device or the device's user is being made. The moderator/host 22 (the function of which may be fully automated by a processor or with a live presenter) controls and directs the flow of information over the local wireless network.

For the local wireless network formed around the wireless access point(s) 21, an 802.11 WiFi local wireless network is preferred but local wireless networks can be formed by Bluetooth connections, WiFi and Bluetooth mesh networks, and other communication protocols, such as infrared, RF, and even combinations and/or hybrids of these technologies. This local wireless network communications channel operates under the standards of IEEE 802.11. Attendee/participant audio data, i.e., the electronic audio data signals, are sent using UDP (User Datagram Protocol) and the control signals are sent using TCP (Transmission Control Protocol). Other protocols are possible. For example, TCP may be used for the audio data transport protocol, and other transport media, which might not be based on UDP or TCP might be used.

Programmable personal mobile communication devices can be in many forms, for example, smart phones, PDA's (Personal Digital Assistants), electronic tablets or pads, such as the Apple iPad, the ASUS Nexus, the Samsung Galaxy and other devices which are equipped with WiFi radio. To allow the programmable personal mobile communications devices 10 of the attendee/participants and moderator/host 22 to operate as described above, software in the form of an “app” is installed in the devices. Programmable mobile communications devices, such as smart phones, have software which is built into the device hardware by the manufacturer to perform the basic functions of the smart phone. Since smart phones are in effect computers with telephonic functions, most, if not all, smart phones are programmable for applications beyond these basic functions. The application programs which fit over the built-in software are apps. For example, an app in the smart phone 10 allows an attendee/participant to communicate with another smart phone 22 (the host/moderator) through the wireless access point 21. With connection to the public address system, i.e., the amplifiers 16 and speakers 17, the app permits the smart phone 10 to function as a microphone for the attendee/participant. Since smart phones are nearly ubiquitous in modern society, the programmable personal mobile communications devices below are described as smart phones, though it should be understood that the devices should not necessarily be so limited. An app for the programmable personal mobile communications device 22 allows the host/moderator to manage the activities of the meeting.

The apps for the attendees/participants' devices 10 and device 22 for the host/moderator are more fully described in U.S. application Ser. No. 14/218,823, filed Mar. 18, 2014 and entitled “Mobile Microphone System Portal App for Meetings,” which is incorporated herein by reference for all purposes. Through the app on a smart phone 10 an attendee/participant can request access to the public address system. The app on the host/moderator device 22 manages the requests from the attendees/participants and grants access to a selected device 10. With connection to the public address system the selected attendee/participant can communicate to the rest of the attendees/participants through the public address system through his or her device 10 operating as a microphone. With the app on the smart phone 10 there is included a software development kit (SDK) which allows further apps, add-ons, etc. to be developed to work with the described app on the smart phone 10.

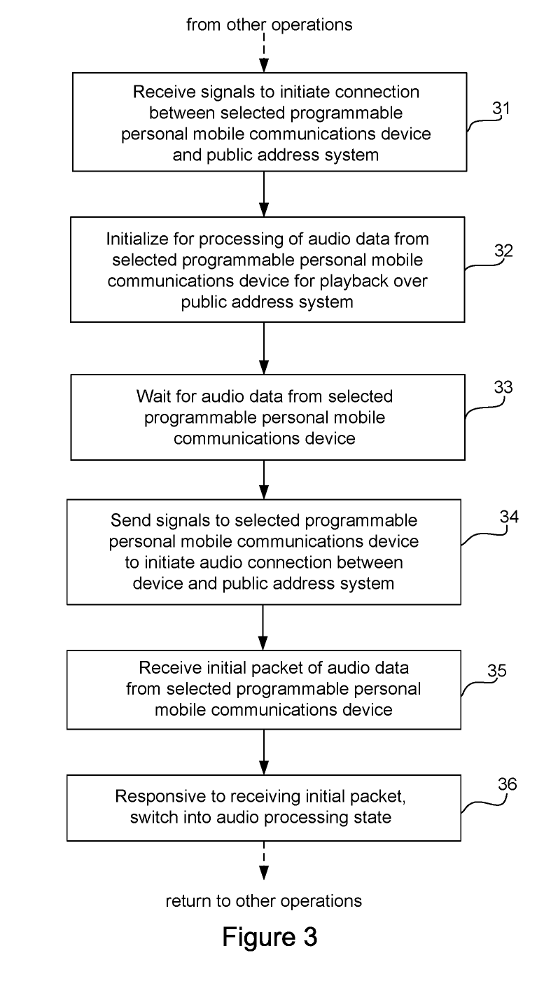

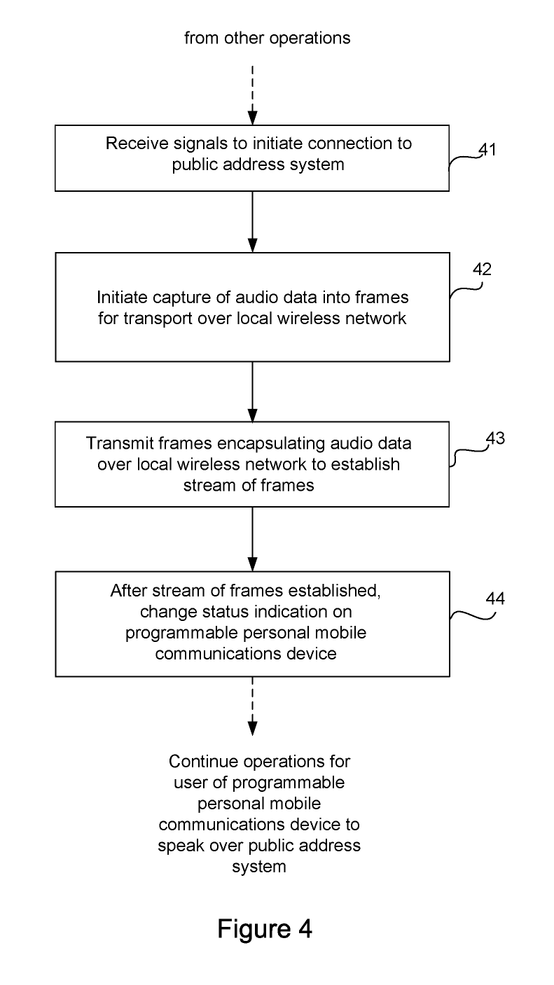

The present invention is directed toward reducing the time in making the initial connection between the selected programmable personal mobile communications device 10 to the public address system, as represented by the amplifier 16 and speakers 17. According to one embodiment of the present invention, FIGS. 3 and 4 show some of the basic steps of the operation flow of the control server 25 and a smart phone 10 respectively to initiate the connection of the smart phone 10 over the local wireless network to the public address system.

In accordance to one embodiment of the present invention, after the host/moderator 22 selects a particular smart phone 10, the host/moderator 22 sends signals to the control server 25 to initiate connection for the selected smart phone 10 to the public address system. The control server 25 upon receiving the signals (step 31 in FIG. 3), initializes itself for the processing of audio data (signals) from the selected smart phone for playback over the public address system (step 32 in FIG. 3) The server 25 then waits for the incoming audio data without transitioning into an audio data processing state (step 33) and sends signals through the local wireless communications network to the selected smart phone to initiate sending of audio data to the public address system through the local wireless communications network (step 34). Upon receiving the initial packet of audio data over the local wireless network from the selected smart phone (step 35), the controller 25 then switches into the audio processing state to playback the audio data from the selected smart phone over the public address system (step 35).

In the described operation above, the control server 25 upon initializing for the audio processing does not switch into the audio processing state. Rather, the control server 25 switches into the audio processing state upon receiving the first audio packet from the selected smart phone 10. This reduces the time in initiating the audio connection Otherwise, the control server 25 is playing back audio while there is no actual audio data to play, adding to latency.

To reduce time in making the initial connection to the local wireless network, the smart phone 10, upon receiving signals from the control server 25 to initiate audio connection to the public address system through the local wireless communications network (step 41 in FIG. 4), initiates the capture of audio data into frames for transport over the local wireless network (step 42 in FIG. 4). The electronic audio data originated from an analog signal generated from a microphone on the smart phone 10 and converted into digital signals by well-known analog-to-digital conversion techniques. The frames encapsulating the audio data are transmitted over the local wireless network to establish a stream of the frames transported over the local wireless network (step 43). Thereafter a status indication on the smart phone 10 is changed to show connection of the selected programmable personal mobile communications device to the public address system (step 44). As a result of the change in status indication, the user interface of the programmable personal mobile communications device changes. Latency in making the initial connection between the smart phone 10 and the public address system is reduced; no time is lost in waiting for the user interface to indicate that the user may speak before making the audio connection. After the described initial connection is made, operations continue for the user of the selected programmable personal mobile communications device to speak over the local wireless network and public address system.

As described above, the operations of the smart phone 10 are governed by the device's basic software and hardware, the app and the SDK for the app. From a software architecture standpoint, the SDK sits between the smart phone basic software/hardware and the app which controls the user interface. When the SDK receives signals over the local wireless network, WiFi in this embodiment, the basic software/hardware processes the signals and the SDK handles the audio data and control signals. When the smart phone 10 receives the control signals through the local wireless communications network from the controller 25 to initiate sending of audio data to the public address system, the SDK accepts the received signals and initiates the capture of the audio data into frames for transport over the local wireless network. The SDK then sends the frames over the local wireless network and also sends change status indication signals to the user interface of the device with the establishment of the audio data stream. In response, the user interface shows that the smart phone 10 is now communicating over the local wireless network and the public address system, i.e., smart phone is now acting as a microphone for the public address system.

Without these improvements above, it has been found that there is a significant time interval in making the initial connection. From the moment the host/moderator 22 sends signals to the control server 25 to initiate connection to a selected attendee/participant device 10 to the moment that the packets of audio data are received from the selected device 10 by the control server 25 has been found to vary from 70 to 200 ms depending upon the situation and the particular smart phone. The described invention significantly reduces this delay for the selected smart phone to make the connection to the local wireless network.

Furthermore, the present invention is suitable for other communications data streams, such as video data and photographs. Instead of audio data and the public address system, video data captured by the selected attendee/participant and his/her device 10 can be sent over the local wireless network to the control server 25 and on to the public display system 19 (see FIG. 2) for viewing by the audience. Through the operations described above, the delay for a smart phone 10 to make a connection to the local wireless network and the public display system is reduced. In this embodiment of the present invention, “video data” and “public display” are substituted for “audio data” and “public address system” in the operational steps of FIGS. 3 and 4. “Video processing state” is also substituted for “audio processing state” in step 36 of FIG. 3. Thus an audience member can show his/her video to an audience with a reduced delay in making the initial connection between his/her selected programmable personal mobile communications device and the visual display system 19.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A method of operation by a computer/server controlling a local wireless network, the local wireless network providing a connection to one or more programmable personal mobile communications devices to a public display/address system, comprising:
receiving signals through the local wireless network to initiate a connection from a selected programmable personal mobile communications device to the public display/address system through the local wireless communications network;
initializing the processing of communications data from the selected programmable personal mobile communications device for playback over the public display/address system;
waiting for communications data from the selected programmable personal mobile communications device;
sending signals through the local wireless network to the selected programmable personal mobile communications device to initiate connection from the selected programmable personal mobile communications device to the public display/address system through the local wireless network;
receiving an initial packet of the communications data over the local wireless network from the selected programmable personal mobile communications device; and
responsive to the step of receiving the initial communications packet, switching into a communications data processing state to playback the communications data from the selected programmable personal mobile communications device over the public display/address system;
whereby the time in initiating the connection is reduced.

2. The method of claim 1 wherein in the receiving signals through the local wireless network step, the received signals comprise signals from a host/moderator device.

3. The method of claim 1 wherein the local wireless network comprises a WiFi network.

4. The method of claim 1 wherein the selected programmable personal mobile communications device comprises a smart phone.

5. The method of claim 1 wherein the selected programmable personal mobile communications device comprises a laptop computer.

6. The method of claim 1 wherein the selected programmable personal mobile communications device comprises a tablet computer.

7. The method of claim 1 wherein the communications data comprise audio data.

8. The method of claim 1 wherein the communications data comprise video data.

9. A computer/server for controlling a local wireless network, the local wireless network providing a connection for one or more programmable personal mobile communications devices to a public display/address system through a local wireless network, the computer/server comprising:
one or more processing units coupled to a memory holding instructions for one or more processing units;
wherein the one or more processing units are programmed to make a connection for a selected programmable personal mobile communications device to the public display/address system over the local wireless network in a minimized time interval by:
receiving signals through the local wireless network to initiate communications connection from a selected programmable personal mobile communications device to the public display/address system through the local wireless communications network;
initializing the processing of communications data from the selected programmable personal mobile communications device for playback over the public display/address system;
waiting for incoming communications data from the selected programmable personal mobile communications device;
sending signals through the local wireless network to the selected programmable personal mobile communications device to initiate connection from the selected programmable personal mobile communications device to the public display/address system through the local wireless network;
receiving an initial packet of communications data over the local wireless network from the selected programmable personal mobile communications device; and
responsive to the step of receiving the initial communications data packet, switching into a communications processing state to playback the communications data from the selected programmable personal mobile communications device over the public display/address system.

10. The computer/server of claim 9 wherein in the receiving signals through the local wireless network step, the received signals comprise signals from a host/moderator device.

11. The computer/server of claim 9 wherein the local wireless network comprises a WiFi network.

12. The computer/server of claim 9 wherein the selected programmable personal mobile communications device comprises a smart phone.

13. The computer/server of claim 9 wherein the selected programmable personal mobile communications device comprises a laptop computer.

14. The computer/server of claim 9 wherein the selected programmable personal mobile communications device comprises a tablet computer.

15. The computer/server of claim 9 wherein the communications data comprise audio data.

16. The computer/server of claim 9 wherein the communications data comprise video data.

17. A method of operating a programmable personal mobile communications device in connecting the device to a public display/address system through a local wireless communications network, comprising:
receiving signals to initiate connection to the public display/address system through the local wireless communications network;
initiating capture of communications data from the programmable personal mobile communications device into frames for transmission over the local wireless network;
transmitting the frames encapsulating the communications data over the local wireless network to establish a stream of the frames of audiocommunications data over the local wireless network; and
thereafter changing status indication on the personal mobile communications device to show connection of personal mobile communications device to the public display/address system;
whereby latency in making the connection between the personal mobile communications device and the public display/address system is reduced.

18. The method of claim 17 wherein the step of initiating capture of communications data further comprises converting analog signals into digital signals.

19. The method of claim 17 wherein the step of receiving signals to initiate connection comprises receiving the signals from a control server controlling the local wireless network.

20. The method of claim 17 wherein the step of changing status indication further comprises changing a user interface of the personal mobile communications device

21. The method of claim 17 wherein the programmable personal mobile communications device comprises a smart phone.

22. The method of claim 17 wherein the programmable personal mobile communications device comprises a lap top computer.

23. The method of claim 17 wherein the programmable personal mobile communications device comprises a tablet computer.

24. The method of claim 17 wherein the communications data comprise audio data.

25. The method of claim 24 wherein the step of initiating capture of audio data further comprises converting analog signals into digital signals.

26. The method of claim 17 wherein the communications data comprise video data.

27. A programmable personal mobile communications device connectable to a public display/address system over a local wireless network, the programmable personal mobile communications device comprising:
one or more processing units coupled to a memory holding instructions for one or more processing units;
wherein the one or more processing units are programmed so that the programmable personal mobile communications device makes a connection to the public display/address system over the local wireless network by:
receiving signals to initiate connection to the public display/address system through the local wireless communications network;
initiating capture of communications display/data from the programmable personal mobile communications device into frames for transmission over the local wireless network;
transmitting the frames encapsulating the communications data over the local wireless network to establish a stream of the frames of communications data over the local wireless network; and
thereafter changing status indication on the personal mobile communications device to show connection of personal mobile communications device to the public display/address system;
whereby latency in making the connection between the personal mobile communications device and the public display/address system is reduced.

28. The programmable personal mobile communications device of claim 27 wherein the step of initiating capture of audio data further comprises converting analog signals into digital signals.

29. The programmable personal mobile communications device of claim 27 wherein the step of receiving signals to initiate connection to the public address system comprises receiving the signals from a control server controlling the local wireless network.

30. The programmable personal mobile communications device of claim 27 wherein the step of changing status indication further comprises changing a user interface of the personal mobile communications device

31. The programmable personal mobile communications device of claim 27 wherein the programmable personal mobile communications device comprises a smart phone.

32. The programmable personal mobile communications device of claim 27 wherein the programmable personal mobile communications device comprises a lap top computer.

33. The programmable personal mobile communications device of claim 27 wherein the programmable personal mobile communications device comprises a tablet computer.

34. The programmable personal mobile communications device of claim 27 wherein the communications data comprise audio data.

35. The programmable personal mobile communications device of claim 33 wherein the step of initiating capture of audio data further comprises converting analog signals into digital signals.

36. The programmable personal mobile communications device of claim 27 wherein the communications data comprise video data.
